(19) United States
(12) Patent Application Publication
(10) Pub. No.: US 2006/0031205 A1
(43) Pub. Date: Feb. 9, 2006

(54) Method and system for providing information over a network

(75) Inventors: Carl C. Perkins, Santa Ana, CA (US); Duane Brinson, Santa Ana, CA (US)

Correspondence Address: STETINA BRUNDA GARRED & BRUCKER, 75 ENTERPRISE, SUITE 250, ALISO VIEJO, CA, 92656, US

(73) Assignee: USA Revco, LLC, dba Clear Search, Irvine, CA (US)

(21) Appl. No.: 10/955,449

(22) Filed: Sep. 30, 2004

Related U.S. Application Data
(60) Provisional application No. 60/599,782, filed on Aug. 5, 2004.

(51) Int. Cl. G06F 17/30

(52) U.S. Cl. 707/3

(57) ABSTRACT

A method of providing information over the Internet by processing erroneous URLs entered into a Web browser for their relevant word content that approximate the intended URL, and delivering useful information to the user which approximates the information that would have been provided to the user if the intended URL was correctly entered into the Web browser. Preferably, further a search is performed using that relevant word content and a search page is delivered to the user which provides the user with useful information related to the information that would have been provided if the intended URL had been correctly entered into the Web browser.

### RELATED APPLICATION

Priority is claimed from U.S. provisional patent application Ser. No. 60/599,782, filed on Aug. 5, 2004, incorporated herein by reference.

### FIELD OF THE INVENTION

The present invention relates generally to providing information in a computer network, and more particularly, to providing resource information in response to erroneous user requests for resource information in a computer network.

### BACKGROUND OF THE INVENTION

Communication networks such as the Internet have provided an unprecedented channel for commerce. Internet based network systems such as the World Wide Web (“WWW”) are configured as a logical construct comprising interconnected routers and computers, wherein the routers direct packets of information from source computers (e.g., servers) to destination computers (e.g., clients) over an underlying transmission network. Currently, the Internet utilizes the Transmission Control Protocol/Internet Protocol (TCP/IP) to provide connections across different physical mediums and provide access to end users with different hardware.

Every computer connected to the Internet has a unique Internet “address” (IP address). The packets are routed based on the IP addresses of the final destination computers. An IP address consists of four groups of digits separated by dots which indicate the network, subnetwork and local address (e.g., 206.79.181.2) of a computer. Servers generally have a correspondingly unique alphanumeric name known as the domain name under the Domain Name System (DNS). Most business domain names have a top-level domain and a second-level domain separated by dots. The top-level domain indicates the type of organization using the name (e.g., “.com” for commercial, “.org” for non-profit organizations, “.edu” for educational institutions, “.net” for networks, etc.) and the second-level domain is frequently the name of the business. So, a domain name identifies the business that owns a web site and allows a user to locate the web site quickly and easily. An alphanumeric domain name much such as dailyjournal.com is more user friendly than its corresponding IP address 206.79.181.2.

Because of its expanse and accessibility, increasingly the WWW is utilized as a means of obtaining commerce for items (e.g., goods, services, etc.) listed in data bases on web-servers world wide. For example, in many WWW applications, lists of items for purchase are collected on web-servers for access and viewing by end-user computer systems. A user typically utilizes a personal computer or a terminal with a Web browser to establish a connection with a Web-server of a merchant or information source through the Internet and searches the Web-server for information. To access a merchant or information source, a user enters a uniform resource locator (URL) address into the Web browser. The URL includes the domain address of a Web-server and the identification of the information source. When a user makes an error in typing an intended URL in the address bar of the Web browser or clicks a bad link, an empty page shows up in the browser displaying “404 error”. This is an undesirable result because the user is provided with information that may not be of direct help to the user in obtaining information that would have been provided if the intended URL was correctly entered into the Web browser.

There is, therefore, a need for a method and system of processing erroneous URLs for their relevant word content that approximate the intended URL, and delivering useful information to the user that approximates the information that would have been provided to the user if the intended URL was correctly entered into the Web browser. Further, it is desirable to perform a search using that relevant word content and deliver a search page to the user that provides the user with useful information related to the information that would have been provided if the intended URL had been correctly entered into the Web browser.

### BRIEF SUMMARY OF THE INVENTION

In one embodiment, the present invention provides a method of supplying information over the Internet by processing erroneous URLs entered into a Web browser for their relevant word content that approximate the intended URL, and delivering useful information to the user which approximates the information that would have been provided to the user if the intended URL was correctly entered into the Web browser. Preferably, further, a search is performed using that relevant word content and a search page is delivered to the user which provides the user with useful information related to the information that would have been provided if the intended URL had been correctly entered into the Web browser.

In one implementation, such a method of supplying information over a network of client and server devices, comprises the steps of: obtaining a URL address at a client device from a user; determining if the obtained URL address is valid; if the obtained URL address is not valid, then analyzing that invalid URL address and providing a new URL address based on that invalid URL address, wherein the new URL address directs the user to information relevant to that invalid URL address. The step of analyzing the invalid URL address further includes the steps of: parsing the invalid URL address for word content; providing a table of selected terms; searching the table for one or more terms matching one or more words of the word content; and performing an information search using one or more of any matching terms, and providing the search results to the client device for user review. Preferably, the table of terms includes terms therein selected based on certain criteria, more preferably selected search words, and most preferably selected search words that comprise pay-per-click (PPC) words.

In another embodiment the present invention provides a system for providing information over a network, comprising: a client device including a web browser and an agent; a server device including an analyzer; the agent is configured to obtain a URL address from a user through the web browser and to determine if the obtained URL address is valid, wherein if the obtained URL address is not valid, then the agent sends the invalid URL address to the analyzer; and the analyzer, configured to analyze that invalid URL address for words found in that invalid URL and provide a new URL address to the Web browser based on that invalid URL address, wherein the new URL address directs the user to information relevant words found in the invalid URL address.

Other embodiments, features and advantages of the present invention will be apparent from the following specification taken in conjunction with the following drawings.

### BRIEF DESCRIPTION OF THE DRAWINGS

FIG. 1 shows a functional block diagram of an example embodiment of a system according to the present invention;

FIG. 2 shows an example response page to an invalid URL address;

FIG. 3 shows an example page of words containing an example search term from a PPC dictionary;

FIG. 4 shows an example flow chart of the steps performed by an embodiment of the plug-in module of FIG. 1;

FIGS. 5A-E show example flow charts of the steps performed by an embodiment of the analyzer module of FIG. 1; and

FIG. 6 shows a flowchart of the steps of an example loader application according to another embodiment of the present invention.

### DETAILED DESCRIPTION OF THE INVENTION

In one embodiment, the present invention provides a method of processing erroneous URLs for their relevant word content that approximate the intended URL, and delivering useful information to the user that approximates the information that would have been provided to the user if the intended URL was correctly entered into the Web browser. Preferably, the method further includes the steps of performing a search using that relevant word content and delivering a search page to the user that provides the user with useful information related to the information that would have been provided if the intended URL had been correctly entered into the Web browser.

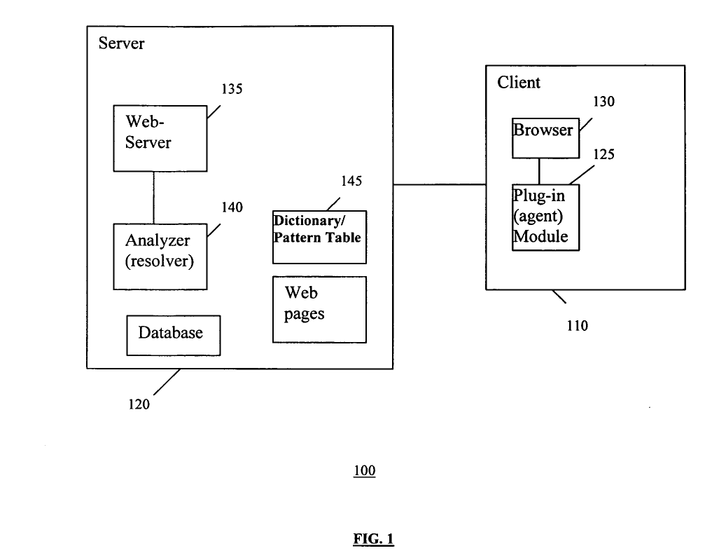

Referring to FIG. 1, an example network 100 including a logical client device 110 and logical server device 120 interconnected through e.g. the Internet. In this example, a plug-in module 125 is provided for a Web browser 130 in the client device 110, wherein the plug-in module 125 captures the erroneous URLs (“404 Error Traffic”) of the Web-browser 130. In one example, the plug-in module 125 is downloaded and installed on the user's Web browser 130 from a Web server 135 in the server 120. The plug-in module 125 sends the erroneous URLs to the server 120 which includes an analyzer (resolver) module 140. The analyzer 140 processes the erroneous URLs sent by the plug-in 125, for relevant word content that approximate the intended URLs. The Web server then delivers to the Web browser useful information that approximates the information that would have been provided to the user if the intended URLs were correctly entered into the Web browser 130. In one example, said relevant word content is delivered to e.g. Lycosm which, in turn, delivers a pay-per-click. (PPC) search page based on Goggle's Adword™ technology to the Web browser 130.

In one embodiment the analyzer 140 rapidly finds word content in an erroneous URL and its corresponding path, and compares it to one or more pattern tables 145, including e.g. a 230,000 word modified American Heritage dictionary. The example analyzer 140 is configured to e.g. parse words in relation to the dictionaries, determine how plurals are utilized in a phrase, handle nuances of the English language, etc. Additionally, the analyzer 140 may map words found to higher value or more relevant words to be delivered to a search engine (e.g., delivered to Lycos™ to return a PPC search) to generate search results that are send to the user's Web browser for review.

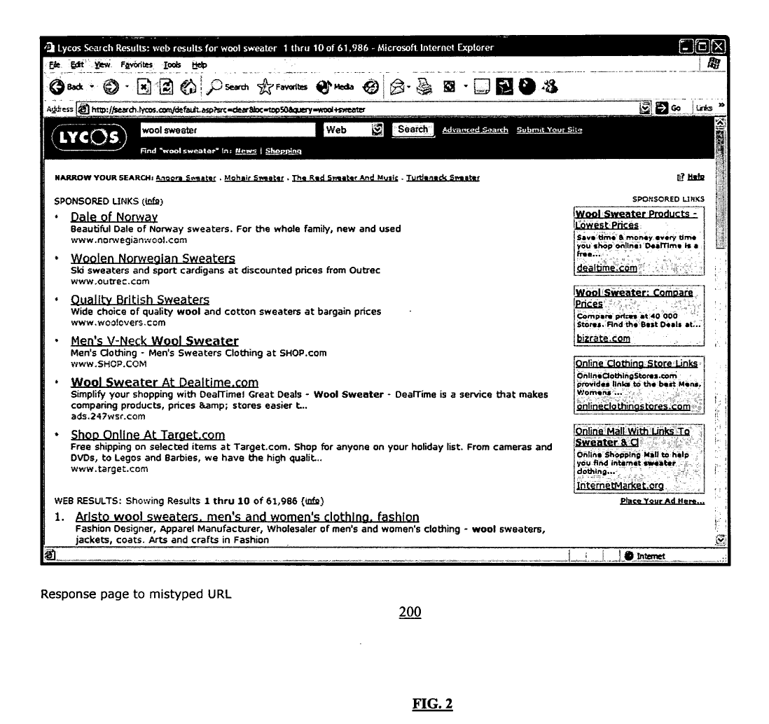

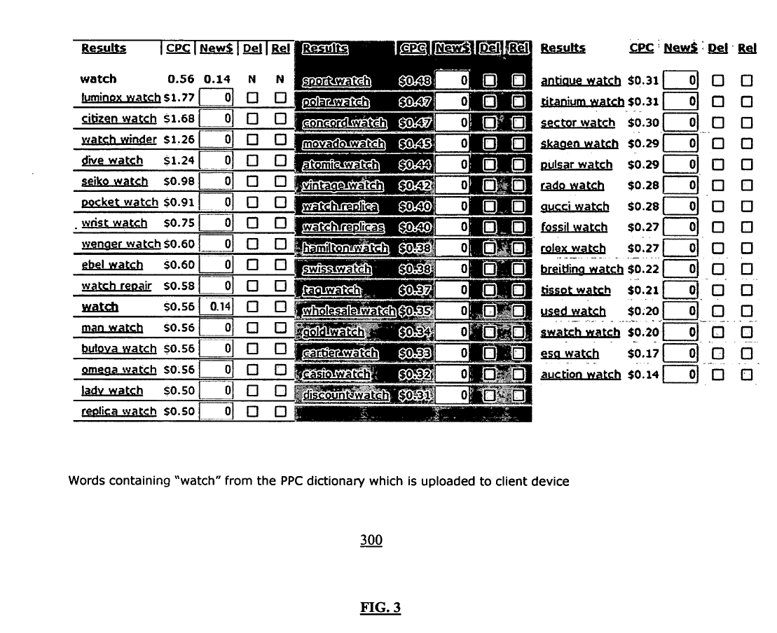

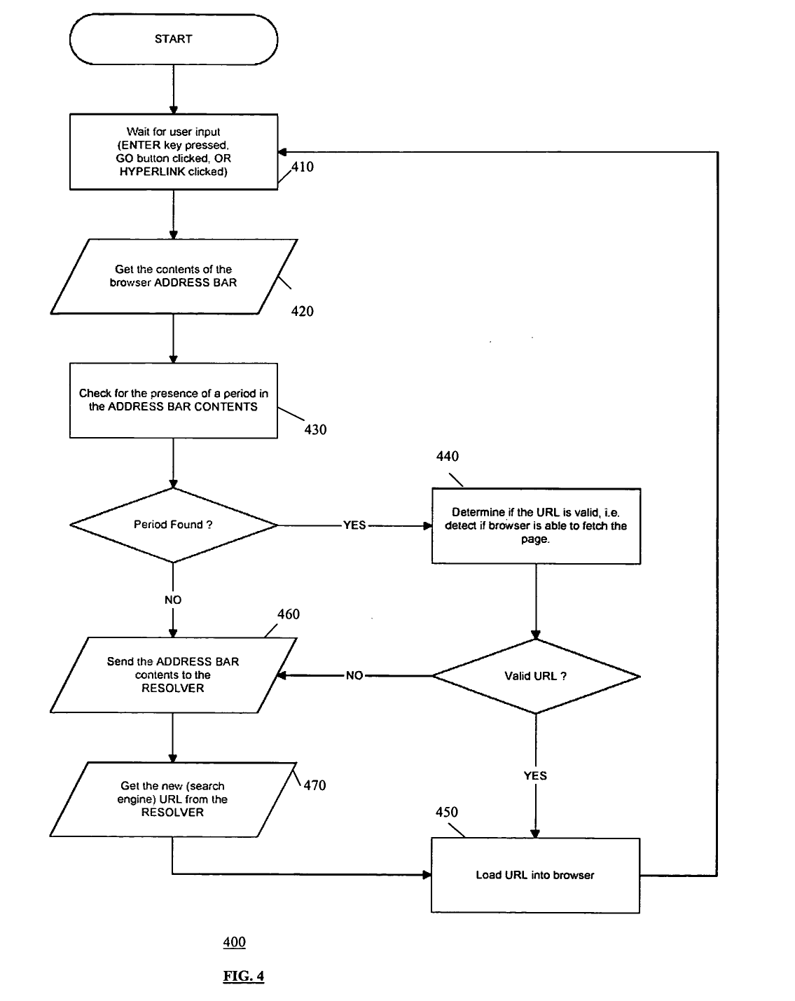

In parsing an erroneous URL, in one example the analyzer 140 uses a database of search terms, known to be of most interest to many users. For example, when the user types in www.woolsweaters.cm (an erroneous URL, bad links, etc.) into the address bar of the Web browser 130, the plug-in 125 for the Web browser 130 sends that URL to the server 120. The analyzer 140 in the server 120 parses the URL to obtain the words “wool” and “sweaters”. The server 120 then sends these words to Lycos™ which returns a Google™ PPC page 200 (e.g., FIG. 2) to the server 120, wherein the server 120 sends the PPC page back to the Web browser 130 for display. Note that in the example page 200 in FIG. 2, the top 6 links are PPC links as well as advertisements in the boxes to the right.

Because the plug-in 125 and analyzer 140 are capable of monitoring and analyzing URLs for 404 errors, the plug-in 125 and analyzer 140 can also watch for and resolve search terms typed directly into the address bar of the browser 130. Roughly 20% of all the address bar traffic (e.g., 404 errors, bad links and search words) are search terms. When a user types search terms directly into the address bar of the Web browser 130, in one example, the plug-in 125 passes the search terms to the analyzer 140, which then passes them to Lycos™ to perform a search on the search terms and generate a search results for display on the Web browser of the user. In another example, the plug-in module sends the search terms typed into the address bar of the browser directly to Lycos™ which performs a search on the search terms and generate search results 200 for display on the Web browser 130. The search results 200 are displayed in the same manner as if the user had navigated to the Lycos™ search page and entered the search terms. The user receives a very relevant response since all of this content is essentially provided by Google™ under a Lycos™ brand.

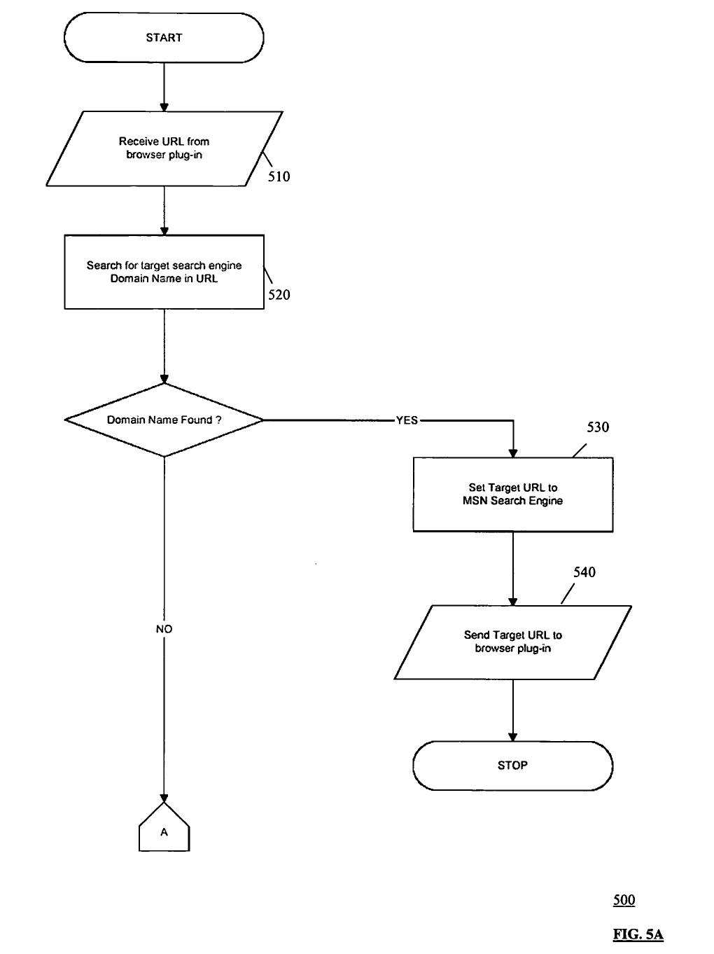

As described by example further below, the number of words of interest to many Web businesses (paid words) is very finite (e.g., on the order of 30,000 words). Many of these words group, such that in one PPC example dictionary, for the word “watch” the complete set of words 300 (FIG. 3) related to watches is only about 50 words. This again simplifies word complexity and, with judicious use of this set of words, the most relevant word combination dependent upon the current context is effectively selected.

An example of Internet searching in relation to general word sets, search resolutions, and smaller word sets such as pay-per-click (PPC) words, is now described. PPC words are words purchased by customers, on a bided basis, from e.g. Google™ and a large number of smaller companies. Companies selling PPC words, purchase space on portals and search engines whereby, when the terms purchased are typed into the search engine, the customers' links and/or advertisements show up ahead of the general resulting search. If, for example, 10 bidders are actively bidding on the same word in Yahoo™, then when that word is searched, the top 3 are displayed ahead of the general search on the first page, then the next highest 3 bids are placed on the top of the second page ahead of the general search, and so on.

PPC words are a particularly interesting group. These are words that have been empirically tested by a large group of buyers (e.g., over 100,000) to be effective in selling a product. An example PPC word base from LookSmart™ is only 31,000 words long, or 0.2% of the 18,000,000 words used in general searches. In example, a very few, 102 words, resulted in tens of millions of resolutions (hits) per month, and over 15,000,000 words resulted in less than ten resolutions per month. This leads to the conclusion that to drive a large percent of search based traffic, only a small number of words, perhaps less than 2,500 words are required, further exemplifying that there are some very finite aspects of a search. Additionally, the average search is about 2.3 words long, further exemplifying that only a small set of word combinations are utilized in a general search.

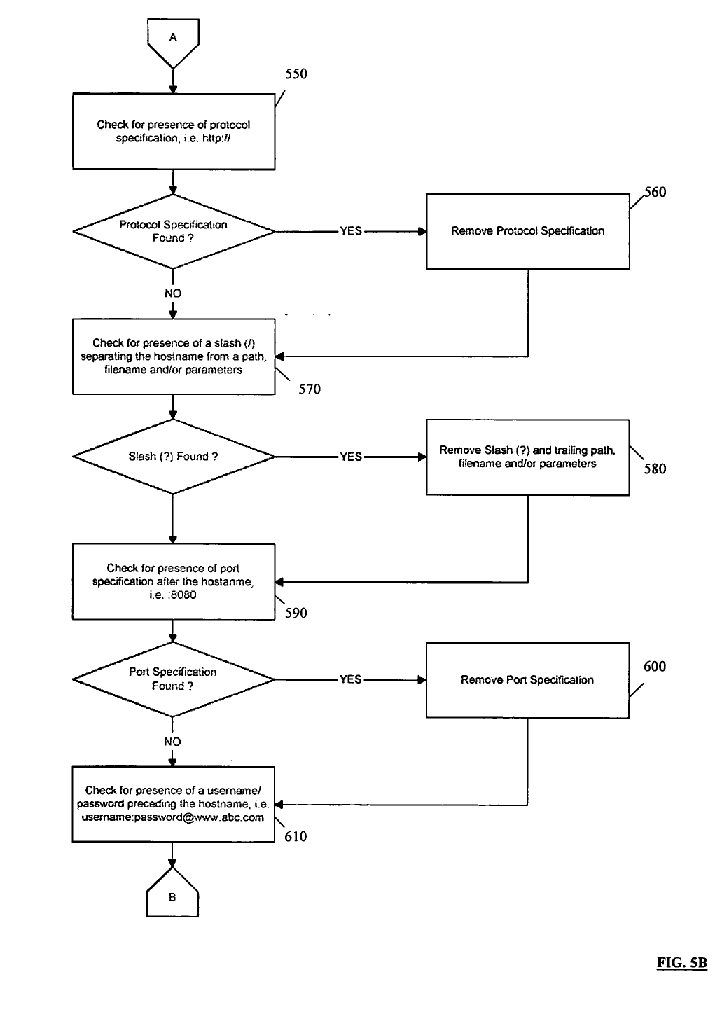

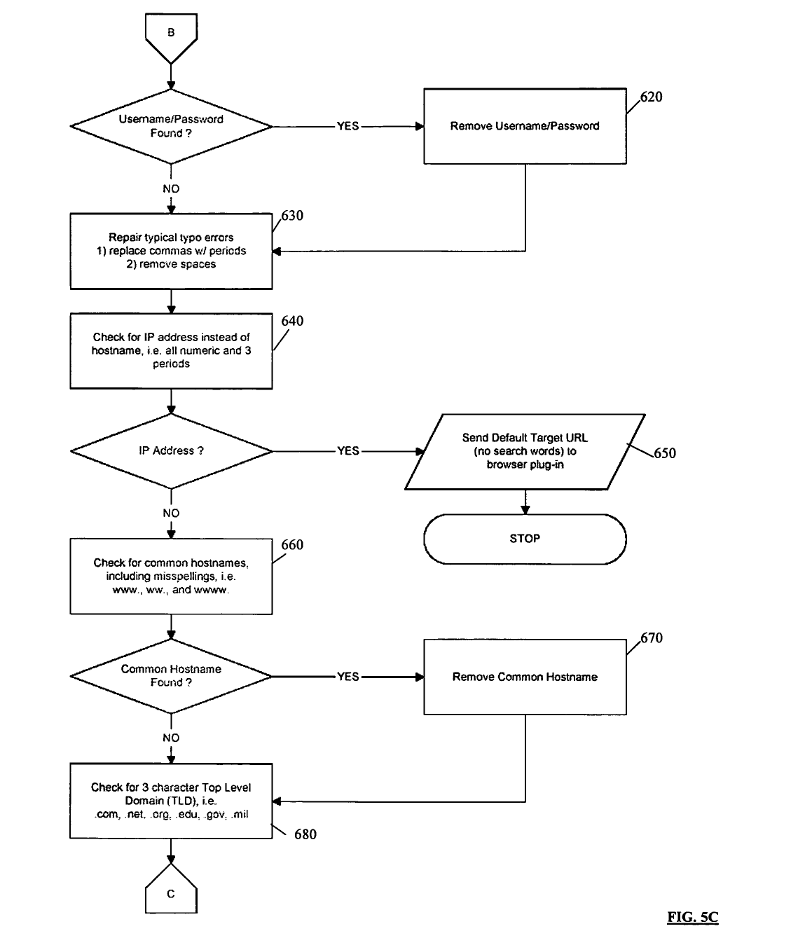

FIG. 4 shows a flowchart 400 of steps implemented in an embodiment of the plug-in 125 according to the present invention. Once installed into the Web browser 130, the plug-in 125 waits for user input (e.g., ENTER key pressed, GO button clicked, HYPERLINK clicked, etc.) (step 410). Once user input is detected, the plug-in 125 obtains the contents of the browser ADDRESS BAR (e.g., http://www.LACARPETS.com, LA Carpets, etc.) (step 420). The plug-in 125 then checks for the presence of a period in the ADDRESS BAR contents (step 430). If a period is found, the plug-in 125 determines if the URL is valid (i.e., detects if the Web-browser is able to fetch the page indicated by the user, e.g., http://www.LACARPETS.com) (step 440). If the URL is valid, the URL is loaded in the Web-browser (step 450), and the process of the plug-in 125 goes back to step 410, to wait for user input. If in step 440, the URL is determined to be invalid (e.g., erroneous) then the plug-in 125 sends the ADDRESS BAR contents to the analyzer (RESOLVER) 140 (step 460). The analyzer 140 analyzes the ADDRESS BAR contents and sends the plug-in 125 a new URL (described further below). Then, in step 470, the plug-in module receives the new URL from the analyzer 140 (e.g., http://www.LACarpets.com/, http://SearchEngine.com/search/?pid=123&cid=abc&query=LA+carpets, etc.), loads the new URL into the Web-browser (step 450) and proceeds to step 410 to await user input. Further, in step 430 above, if the plug-in 125 does not find a period in the ADDRESS BAR content (e.g., LA Carpets), the plug-in 125 proceeds to step 460 to send the ADDRESS BAR contents to the analyzer 140, and performs further processing as described above.

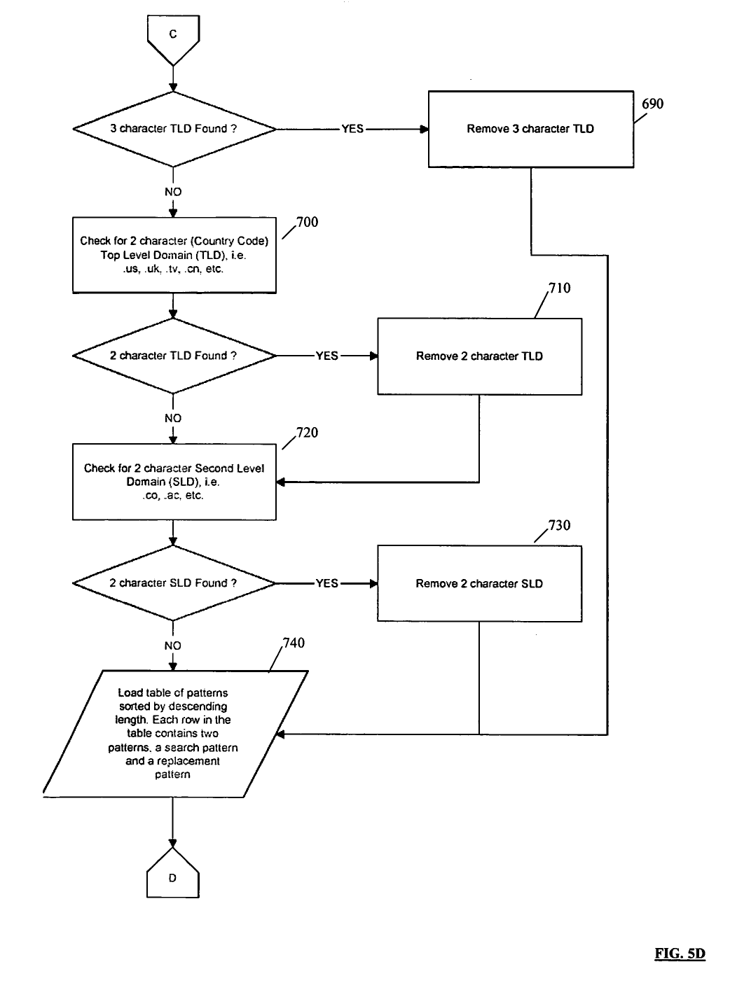

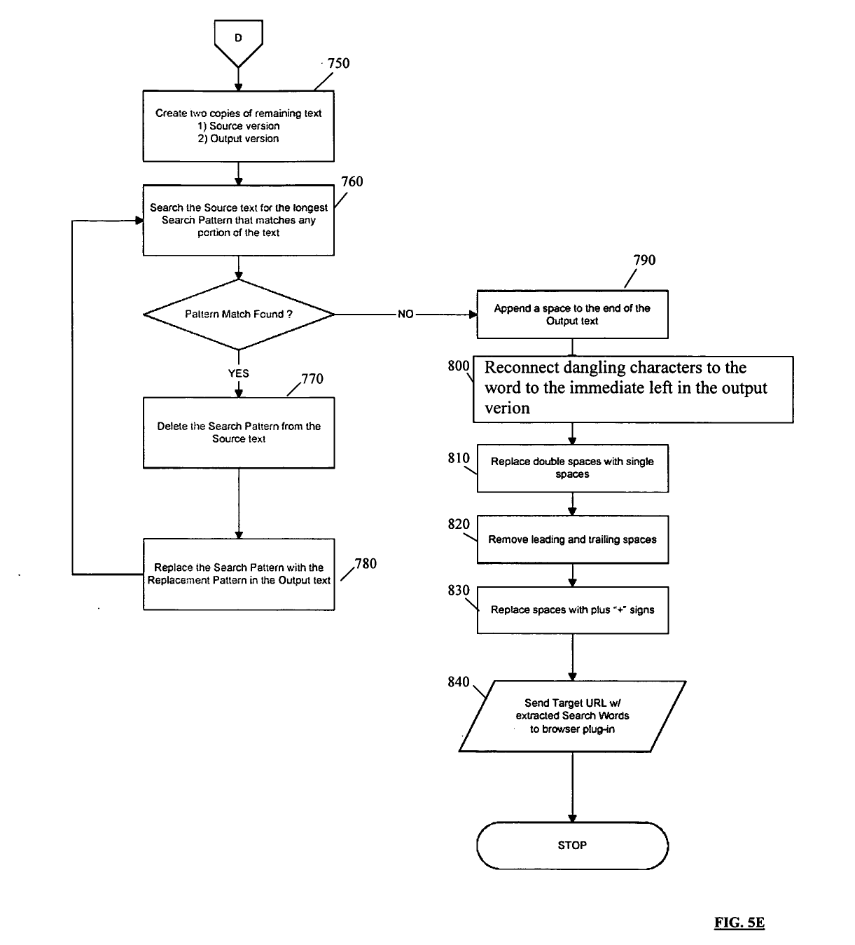

FIGS. 5A-E collectively show a flowchart 500 of steps of an embodiment of the analyzer/resolver 140 according to the present invention. In step 510, the analyzer 140 receives the ADDRESS BAR content URL sent by the plug-in 125 (e.g., http://UserName:Password@www.LosAngelesCarpets.com:8080/samples/default.asp?uid=10&sid=23, www.LosAngelesCarpets.com). The analyzer 140 then determines if there is a Target Search Engine Domain Name in the received URL (e.g., SearchEngine.com) (step 520). If a Target Search Engine Domain Name is found, the analyzer 140 then sets the Target URL to a secondary Search Engine (e.g., MSN Search Engine) (step 530), sends the Target URL to the plug-in 125 (step 540), and proceeds to await receipt of next ADDRESS BAR content URL from the plug-in 125. However, if in step 520 a Target Search Engine Domain Name is not found in the ADDRESS BAR content URL, the analyzer 140 proceeds to step 550 (FIG. 5B) to check the URL for the presence of a protocol specification, such as http:// (e.g., http://UserName:Password@www.LosAngelesCarpets.com:8080/samples/default.asp?uid=10&sid=23, www.LosAngelesCarpets.com). If the protocol specification is found in the URL, then in step 560 it is removed from the URL (e.g., UserName:Password@www.LosAngelesCarpets.com:8080/samples/default.asp?uid=10&sid=23, www.LosAngelesCarpets.com). Then, the presence of a slash (/) separating the hostname from a path, file name and/or parameters in the URL is detected (step 570). If a slash is found in the URL, then, in step 580 it is removed from the trailing path, filename and/or parameters in the URL (e.g., UserName:Password@www.LosAngelesCarpets.com:8080, www.LosAngelesCarpets.com). Then, presence of a port specification (e.g., 8080) after the hostname is detected in the URL (step 590). If a port specification is found in the URL, then in step 600 it is removed from the URL (e.g., UserName:Password@www.LosAngelesCarpets.com, www.LosAngelesCarpets.com). Then, presence of a username/password proceeding the host name is detected in the URL (e.g., username:password@www.abc.com”) (step 610). If username/password is found in the URL, the in step 620 (FIG. 5C) it is removed from the URL (e.g., www.LosAngelesCarpets.com, www.LosAngelesCarpets.com).

Then, typical typographical errors are repaired (e.g., replacing commas with periods, removing spaces, etc.) in the URL (step 630). Further, the URL is checked to determine if an IP address is present (e.g., all numeric and 3 periods in an IP) (step 640). If an IP address is found in the URL, a default Target URL (no search words) is sent back to the Web-browser plug-in 125 (step 650) and the analyzer 140 stops processing this URL. However, if an IP address is not found in the URL, then in step 660, the presence of common hostnames (which provide no relevant information), including misspellings (e.g., www., ww., wwww., etc.) in the URL is detected (step 660). If a common hostname is found, in step 670 it is removed from the URL (e.g., LosAngelesCarpets.com, LosAngelesCarpets.com) Then, in step 680, the URL is checked for 3 character top level domain (TLD) (e.g., .com, net, org, .edu, .gov, .mil, etc.).

If a 3 character TLD is found, then in step 690 (FIG. 5D) it is removed from the URL (e.g., LosAngelesCarpets, LosAngelesCarpets). Further, in step 700 the URL is checked for 2 character country code TLD (e.g., .us, .uk, .cn, etc.). If a 2 character country code TLD is found, then it is removed from the URL (step 710). Then, in step 720 the URL is checked for 2 character second level domain (SLD) (e.g., .co, .ac, etc.). If a 2 character SLD is found, then it is removed from the URL (step 730).

Then, a table of patterns is loaded, wherein each row includes a search pattern and a replacement pattern (step 740). Then, in step 750 (FIG. 5E) two copies of the remaining text in the URL are created: a source version (e.g., “LosAngelesCarpets”) and an output version (e.g., “LosAngelesCarpets”). The source version is then searched for the longest search pattern in the table that matches a portion of the source version (step 760). If a match is found, then the found search pattern is deleted from the source version (step 770). Then, in step 780, in the output version, the search pattern is replaced by the corresponding replacement pattern from the table. For example, in a first pass, if the source version is “LosAngelesCarpets”, the source version becomes “Carpets” and the output version becomes “Los Angeles Carpets”. Then in a second pass the source version would become “s” and the output version “Los Angeles Carpet s”.

The process then proceeds back to step 760, to search the source version again for another pass until no patters are found in the source version.

Then, in step 790 a space is appended to the end of the output version (e.g., “LosAngeles Carpet s”), and in step 800 any dangling characters are reconnected to the word to the immediate left in the output version (e.g., replace “s” with “s” , resulting in “LosAngeles Carpets”). Then, in step 810 double spaces in the output version are replaced with single spaces (e.g., “LosAngeles Carpets”). Then, in step 820 leading and trailing spaces in the output version are removed (e.g., “LosAngeles Carpets”). Then, in step 830 any spaces are replaced by “+” in the output version (e.g., “LosAngeles+Carpets”). Then, in step 840 the output version is sent as the target URL with the extracted search words to the plug-in module of Web-browser (e.g., http://www.SearchEngine.com/search/?pid=123&cid=abc&query=LosAngeles+Carpets).

In general, the default replacement pattern is the same as the search pattern with leading and trailing spaces added to separate the pattern from the surrounding text, but the replacement pattern can be any text with leading and training spaces (e.g., search pattern “LosAngeles” is replaced with replacement pattern “Los Angeles”, search pattern “Carpet” is replaced with replacement pattern “Carpet”, etc.).

As this example shows, the present invention provides a method of processing erroneous URLs for their relevant word content that approximate the intended URL, and delivering useful information to the user that approximates the information that would have been provided to the user if the intended URL was correctly entered into the Web browser. Further, a search using that relevant word content is performed and a search page is delivered to the user which provides the user with useful information related to the information that would have been provided if the intended URL had been correctly entered into the Web browser.

In one example application, such a method can be used for: (1) providing a relevant PPC (pay-per-click) search in response to a 404 error, (2) providing a search (both PPC based links, if applicable or general search response) relative to words typed in the address bar, etc. Revenue can be attained from links clicked, ads clicked, ads displayed, or through affiliate programs, whereby payment is made when a user is sent to a specific site and actually purchases a product.

In one implementation, the analyzer 140 is implemented in software and runs on the server 120 in compiled form. The plug-in module/agent 125 is also implemented in software which uses compiled code on the client device 110, with encrypted rules in a scrambled data form.

The present invention further utilizes a loader application which comprises an executable file initially downloaded and executed by a client device. The loader application is capable of installing and managing the configuration (updates) of any number of secondary applications (as well as updating itself). In one example embodiment, the Loader comprises: (1) a common installer/updater application, (2) a Control file that directs the operation of the installer/updater application and (3) individual DLLs (e.g., Installer Dynamic Link Libraries (DLLs)) that perform the specific operations necessary for installing and updating the actual applications managed by the installer/updater application.

In one embodiment, the Installer DLL comprises two functions called by the installer/updater: a Version function, and a Main function. The Version function reports the version number of the Installer DLL back to the calling application (i.e., the installer/updater application). The Main function performs the actual installation and updating of the secondary application. The Main function obtains any required configuration information, such as target installation directory, custom configuration rules, etc. from the installer/updater application via a common registry key and reports the status of the installation/upgrade operation to the installer/updater application via a numeric result returned by the function.

In some instances, configuration information is obtained in real time from a specialized Web server by providing configuration information obtained from the registry to a dedicated page on the Web server and receiving installation instructions from the Web server. This allows for real time changes in the configuration of the secondary application configuration without the need to modify, test and release new code each time a change is required. Common tasks performed by the Main function include creation of the secondary application's installation directory, creation of the secondary application file (the EXE file) and all required supporting files (DLLs and configuration files), registration of DLLs with the operating system and any other required changes to the registry, such as creation of the uninstaller registry key.

In one example, the Control file comprises an encrypted ASCII file that contains configuration information which directs the operation of the installer/updater application. The plain text (unencrypted) version of the Control file contains a master version number on the first line followed by one or more rule lines. The master version number is incremented each time a change is made to the Control file allowing the installer/updater application to determine when a new version is available. Each rule line in the Control file comprises four fields: a character string that specifies a name for the rule, the version number of the rule, the name of the Installer DLL that implements the rule, and the checksum of the compressed version of the Installer DLL file. The Control file is encrypted to prevent users and other applications from easily modifying the file.

In one embodiment, the installer/updater application performs four main tasks: downloading and installing the applications during the initial installation, verifying the integrity of the applications, checking for updates on a periodic basis, and downloading and installing the updates when they become available. Upon execution, the installer/updater application checks the Windows registry to determine if this is the first time that the installer/updater is running on this system (initial installation) or a subsequent run (boot time load).

During initial execution, the installer/updater performs various initialization tasks and then downloads the latest version of the Control file from a dedicated Web server. The initialization tasks include creation of a common registry key, creation of a Globally Unique Identifier (GUID) to uniquely identify this particular installation, storing of the GUID and other configuration parameters (Promotion code) in the registry key and configuring Windows™ to execute the installer/updater each time the operating system boots. The installer/updater decrypts and parses the Control file to extract the master version number, the number of rules and the name, version, Installer DLL and checksum for each rule.

After the control File has been downloaded, decrypted and parsed, the installer/updater downloads the compressed version of each Installer DLL from the dedicated web server, calculates the checksum of the downloaded (compressed file) and compares the calculated checksum to the expected checksum specified in the rule to verify that the that the compressed Installer DLL file was successfully downloaded. If an error occurred during the downloading of the compressed Installer DLL file (e.g., due to excessive server or network loading), the installer/updater waits a pre-defined amount of time and then retries to download the compressed Installer DLL file. Once the compressed Installer DLL file has been successfully downloaded, the compressed Installer DLL file is decompressed, the checksum of the decompressed file is calculated and the expected checksum in the rule for the Installer DLL is updated to reflect the checksum of the decompressed file on the local computer (vs. the compressed file on the dedicated web server). Once all of the Installer DLL files have been successfully downloaded and decompressed, the updated Control file is written to the local computer to reflect that a complete download of all required files has been successfully completed.

Once all of the Installer DLLs have been successfully downloaded and decompressed, the installer/updater then successively loads each Installer DLL into memory, calls the Version function and compares the reported version with the version specified in the rule to confirm that the correct version of the Installer DLL has been obtained from the server and then calls the Main function to actually implement the Installer DLL, i.e. install the secondary application. The Main function returns a numeric value indicating the results of the installation status which the installer/updater retains for later reporting back to another dedicated web server. After all of the Installer DLLs have been executed, the installer/updater reports the configuration information (GUID, Promotion code, etc.) and the results of each rule (Installer DLL) back to a dedicated web server for tracking and analysis.

When the installer/updater application is executed at boot time, it reads the encrypted Control file from the local computer and then decrypts and parses the Control file. Once the rules in the Control file have been parsed, the installer/updater verifies the checksum of each Installer DLL. If any of the Installer DLL checksums is invalid, then the Control file is marked as invalid. If all of the checksums are valid, then the Installer/Updater loads and executes each Installer DLL to verify that each secondary application has not been corrupted.

Periodically, the installer/updater application queries a dedicated web server to determine if a new version of the Control File has been released. The Installer/Updater reports various configuration information, i.e. Installation ID, GUID, promotion code, etc. back to the web server for tracking and analysis purposes. The server reports the master version number of the latest Control File as well as the checksum of the encrypted version of the Control File on the server. If a new version of the Control File is available, or if the local copy of any Installer DLL has been corrupted, then the latest Control File is downloaded from the server.

After the encrypted Control file has been downloaded, the checksum of the data is calculated and compared to the expected value obtained from the Web server. If the checksums do not match, then the installer/updater waits a predetermined length of time and re-attempts to download the Control file.

Once the Control file has been successfully downloaded, the installer/updater parses the Control file to extract the rules specified in the Control file. The installer/updater then compares the version number of each rule in the local Control file (loaded from the file system) to the version number of the corresponding rule (as determined by the rule name) in the Control file downloaded from the server. If the version of the rule in the Control file obtained from the server is greater than the version number of the rule in the Control file loaded from the local computer, or if the Installer DLL for the rule on the local file system has been corrupted, then the latest version of the compressed Installer DLL is downloaded from the Web server, the checksum of the downloaded (compressed file) is calculated and compared to the expected checksum specified in the rule to verify that the that the compressed Installer DLL file was successfully downloaded. If an error occurred during the downloading of the compressed Installer DLL file, the installer/updater waits a pre-defined amount of time and then retries to download the compressed Installer DLL file. Once the compressed Installer DLL file has been successfully downloaded, the compressed Installer DLL file is decompressed, the checksum of the decompressed file is calculated and the expected checksum of the rule for the Installer DLL in the Control file obtained from the server is updated to reflect the checksum of the decompressed file on the local computer (versus the compressed file on the dedicated web server).

Once all of the updated Installer DLL files have been successfully downloaded and decompressed, the updated Control file obtained from the server is written to the local computer (replacing the local copy of the Control file) to reflect that a complete download of all required files has been successfully completed. If the local computer has the latest version of the Control file and the Installer DLLs, then the installer/updater becomes dormant for the specified amount of time before initiating another check for updates. The installer/updater utilizes almost no system resources while sleeping and terminates when the operating system shuts down.

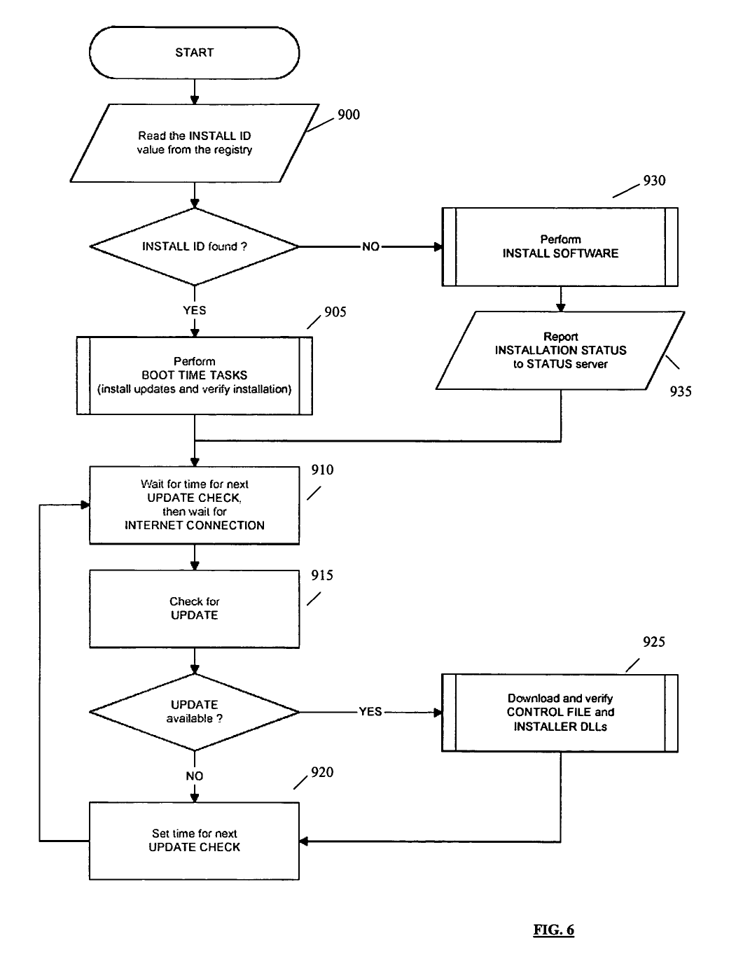

FIG. 6 shows a flowchart of an example operation of the loader (e.g., in the Windows™ operating system), comprising the steps of: Attempting to read an INSTALL ID value from the registry (step 900); If an INSTALL ID was found and read in, then performing BOOT TIME TASKS (e.g., installing updates, verifying installation, etc.) (step 905); Waiting for the next UPDATE CHECK and INTERNET CONNECTION (step 910); Checking for UPDATES (step 915); If UPDATES are not available, then setting the time for the next UPDATE CHECK (step 920) and proceeding back to step 910, otherwise if UPDATES are available, then downloading and verifying the Control file and Installer DLLs (step 925) and proceeding to step 920. Further, back in step 900, if an INSTALL ID was not found, then performing INSTALL SOFTWARE (step 930), reporting INSTALLATION STATUS to a STATUS server, (step 935), and proceeding to step 910.

In one embodiment, the loader application executes separately from the plug-in and the resolver. The loader communicates with two servers, which are different than the server(s) that the plug-in communicates with. The loader queries a server (e.g., STATUS) to report installation status and to obtain the master version number of the latest Control file. The loader also obtains the checksum of the control file, the control file itself and the installer DLLs from another server (e.g., software distribution server).

The loader does not interact with the plug-in or the resolver server directly. The loader configures the operating system (e.g., Windows™) to execute the loader at boot time, and checks for updates, and then installs the updates on the next re-boot of the computer as the plug-in cannot be updated while Windows™ is running.

The plug-in is loaded by Windows™ at the completion of the boot process and by each subsequent instance of either the browser (e.g., Windows Explorer (explorer.exe) or Internet Explorer (iexplore.exe)) and interfaces to the resolver server(s).

While this invention is susceptible of embodiments in many different forms, there are shown in the drawings and will herein be described in detail, preferred embodiments of the invention with the understanding that the present disclosure is to be considered as an exemplification of the principles of the invention and is not intended to limit the broad aspects of the invention to the embodiments illustrated. The aforementioned example architectures above according to the present invention, can be implemented in many ways, such as program instructions for execution by a processor, as logic circuits, as ASIC, as firmware, etc., as is known to those skilled in the art. Therefore, the present invention is not limited to the example embodiments described herein.

The present invention has been described in considerable detail with reference to certain preferred versions thereof; however, other versions are possible. Therefore, the spirit and scope of the appended claims should not be limited to the description of the preferred versions contained herein.

What is claimed is:

1. A method for providing information over a network of client and server devices, comprising the steps of:
obtaining a URL address at a client device from a user;
determining if the obtained URL address is valid;
if the obtained URL address is not valid, then analyzing that invalid URL address and providing a new URL address based on that invalid URL address, wherein the new URL address directs the user to information relevant to that invalid URL address.

2. The method of claim 1, wherein the step of analyzing the invalid URL address further includes the steps of:
parsing the invalid URL address for word content;
providing a table of selected terms;
searching the table for one or more terms matching one or more words of the word content; and
performing an information search using one or more of any matching terms, and providing the search results to the client device for user review.

3. The method of claim 2, wherein the step of providing the table of terms further includes the steps of providing the table of terms such that the terms therein are selected based on certain criteria.

4. The method of claim 3, wherein the step of providing the table of terms further includes the steps of providing the table of terms such that the terms therein are selected search words.

5. The method of claim 4, wherein the selected search words comprise PPC words.

6. The method of claim 2, wherein the steps of parsing the invalid URL address, further includes the steps of searching for a target search engine domain name.

7. The method of claim 6, further comprising the steps of: removing any protocol specifications from the invalid URL address.

8. The method of claim 7, further comprising the steps of: removing any slashes in the invalid URL address which separate a hostname from a path, file name and/or parameters.

9. The method of claim 8, further comprising the steps of: removing any port specifications from the invalid URL address.

10. The method of claim 9, further comprising the steps of: removing any unsername/password from the invalid URL address.

11. The method of claim 10, further comprising the steps of: correcting certain typographical errors in the invalid URL address.

12. The method of claim 11, further comprising the steps of: checking for an IP address in the invalid URL address, such that, if an IP address is not found, then checking for certain non-relevant host names in the URL address, and removing any such hostnames from the invalid URL address.

13. The method of claim 12, further comprising the steps of: removing any top level domain names from the invalid URL address.

14. The method of claim 12, further comprising the steps of: removing any country codes from the invalid URL address.

15. The method of claim 14, further comprising the steps of: removing any non-relevant second level domain names from the invalid URL address.

16. A system for providing information over a network, comprising:
a client device including a web browser and an agent;
a server device including an analyzer;
the agent is configured to obtain a URL address from a user through the web browser and to determine if the obtained URL address is valid, wherein if the obtained URL address is not valid, then the agent sends the invalid URL address to the analyzer;
the analyzer configured to analyze that invalid URL address and provide a new URL address to the Web browser based on that invalid URL address, wherein the new URL address directs the user to information relevant to that invalid URL address.

17. The system of claim 16, wherein the analyzer analyzes the invalid URL address by:
parsing the invalid URL address for word content;
searching the table of selected terms for one or more terms matching one or more words of the word content; and
performing an information search using one or more of any matching terms, and providing the search results to the web browser for user review.

18. The system of claim 17, wherein the terms in the table are selected based on certain criteria.

19. The system of claim 18, wherein the terms in the table are selected search words.

20. The system of claim 19, wherein the selected search words comprise PPC words.

21. The system of claim 17, wherein the analyzer parses the invalid URL address by searching for a target search engine domain name.

22. The system of claim 21, wherein the analyzer further removes any protocol specifications from the invalid URL address.

23. The system of claim 22, wherein the analyzer further removes any slashes in the invalid URL address which separate a hostname from a path, file name and/or parameters.

24. The system of claim 23, wherein the analyzer further removes any port specifications from the invalid URL address.

25. The system of claim 24, wherein the analyzer further removes any unsername/password from the invalid URL address.

26. The system of claim 25, wherein the analyzer further corrects certain typographical errors in the invalid URL address.

27. The system of claim 26, wherein the analyzer further checks for an IP address in the invalid URL address, such that, if an IP address is not found, then the analyzer checks for certain non-relevant host names in the URL address, and removes any such hostnames from the invalid URL address.

28. The system of claim 27, wherein the analyzer further removes any top level domain names from the invalid URL address.

29. The system of claim 28, wherein the analyzer further removes any country codes from the invalid URL address.

30. The system of claim 29, wherein the analyzer further removes any non-relevant second level domain names from the invalid URL address.
